(19) United States
(12) Patent Application Publication
(10) Pub. No.: US 2011/0161938 A1
(43) Pub. Date: Jun. 30, 2011

(54) INCLUDING DEFECT CONTENT IN SOURCE CODE AND PRODUCING QUALITY REPORTS FROM THE SAME

(75) Inventors: MATTHEW G. MARUM, RESEARCH TRIANGLE PARK, NC (US); NIRAV S. SHETH, RESEARCH TRIANGLE PARK, NC (US); STEVEN K. SPEICHER, RESEARCH TRIANGLE PARK, NC (US); MICHAEL J. TABB, RESEARCH TRIANGLE PARK, NC (US)

(73) Assignee: INTERNATIONAL BUSINESS MACHINES CORPORATION, ARMONK, NY (US)

(21) Appl. No.: 12/650,445

(22) Filed: Dec. 30, 2009

(51) Int. Cl. G06F 17/30; G06F 9/44

(52) U.S. Cl. 717/131; 707/769; 707/706; 707/E17.108

(57) ABSTRACT

Defect content for a computer program product can be stored with source code of the computer program product. A computer program product analysis tool having a graphical user interface can be provided. Search criteria for defect content for the computer program product can be specified by a user via the graphical user interface. The stored defect content of the source code of the computer program product can be searched based on the search criteria. A computer program product quality report can be produced for the computer program product based on results of the searching of the stored defect content.

### BACKGROUND

The present invention relates to the field of computer program product analysis and, more particularly, to including defect content in source code and producing quality reports from the same.

Code of computer program products can be of varying quality, which can be difficult to access. Quality is often defined by an internal organization and consistency of the code and whether or not the code includes potential or actual defects. Quality assessments of code are typically needed during an acquisition of a company to attempt to determine a quality of code it is acquiring.

Quality assessments are typically performed using static or dynamic code analysis techniques. Static code analysis is performed on some version of source code (or object code). Static code analysis can highlight possible coding errors (e.g., a Lint or Lint-like tool) and/or can use formal methods that mathematically provide properties of a program, such as that behavior of code matches its specification. Formal methods can include model checking, data flow analysis, abstract interpretation, use of assertions in program code, and the like. Static code analysis methods can be time consuming and costly to perform.

Dynamic code analysis is performed by running executables with sufficient test input to produce interesting behavior. Effectively, dynamic testing should be performed with sufficient code coverage to ensure that an adequate slice of possible behavior has been observed. It is impractical (often too time consuming and expensive) for quality code assessors to perform substantial dynamic code analysis. Records of historic dynamic code analysis for a computer program product can be ill maintained and difficult to verify at a time of a quality assessment. This is especially true for computer program products that have transitioned through different change tracking systems over a lifetime of the computer program products. Further complicating matters is software re-use principles often resulting in a computer program product consisting of a myriad of different interactive components, each of which must be assessed for quality to reasonably determine an overall quality of the combined product.

### BRIEF SUMMARY

One aspect of the disclosure stores defect content (defect information or a reference to defect information) for a computer program product within source code of the computer program product. Additionally, a computer program product analysis tool having a graphical user interface can be provided. Search criteria for defect content for the computer program product can be specified by a user via the graphical user interface. The stored defect content of the source code of the computer program product can be searched based on the search criteria. A computer program product quality report can be produced for the computer program product based on results of the searching of the stored defect content.

One aspect of the disclosure concerns a system for producing computer program product quality reports. The system can include a tangible storage medium, a defect search engine, an analysis engine, and a report engine. Each of the engines can include computer program products stored in a tangible medium that performs functions when executed by hardware. The tangible storage medium can store a set of different source code files. Each source code file can include source code and defect content. Defect content can include defect information or a reference to defect information. The defect content can be included within the source code files in a non-interfering manner with the source code, such that the included defect content is ignored when the source code is compiled or interpreted. The defect search engine can search the different source code files for defect content matching specified search criteria. The analysis engine can manipulate matching results from the defect search engine and can compute metrics for searches conducted by the defect search engine. The report engine can produce computer program product quality reports for computer program products based search criteria given to the defect search engine, manipulated matching results from the analysis engine, and metrics computed by the analysis engine.

### BRIEF DESCRIPTION OF THE SEVERAL VIEWS OF THE DRAWINGS

FIG. 1 illustrates a system for using defect content contained in source code files to assess quality of a computer program product in accordance with an embodiment of the disclosure.

FIG. 2 is a flow chart of a method for including defect content with source code and for producing quality reports based on the defect content in accordance with an embodiment of the disclosure.

FIG. 3 is a diagram illustrating a set of process flows for embedding defect content within a source code files throughout a software development process in accordance with an embodiment of the disclosure.

FIG. 4. is a schematic diagram illustrating a system for including defect content within a source code file in accordance with an embodiment of the disclosure.

FIG. 5 illustrates embodiments for including defect content within a source code file in accordance with an embodiment of the disclosure.

### DETAILED DESCRIPTION

The present disclosure includes code defect content in source code files of a corresponding computer program product. In one embodiment, the source code file or document itself can be annotated with embedded defect information. In another embodiment, an index can be added to source code, which can be linked to a companion set of files containing defect information. Regardless, the defect content can be stored in a non-interfering manner—meaning the defect information is ignored when the source code is compiled or interpreted. The defect content and/or information can include version information, testing output, inventor comments, fix information, and the like. The embedding of information can occur during software testing phases, deployment phases, production phases, and/or maintenance phases of a lifecycle of a computer program product.

Once defect content has been included in source code files, the source code files can be searched or queried to produce defect reports and/or quality reports. Reports can show a current status of defects, can show a quantity of open and/or closed defects, and the like. Thus, quality reports for computer program products can be directly generated based exclusively on the defect content included in the source code files. Thus, no statistical code analysis or dynamic code analysis is needed to generate an accurate quality report. Since the defect content is contained in source code files, it persists and can be utilized by a standard analysis tool regardless of which change tracking systems have been used over a lifetime of a corresponding computer program product.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

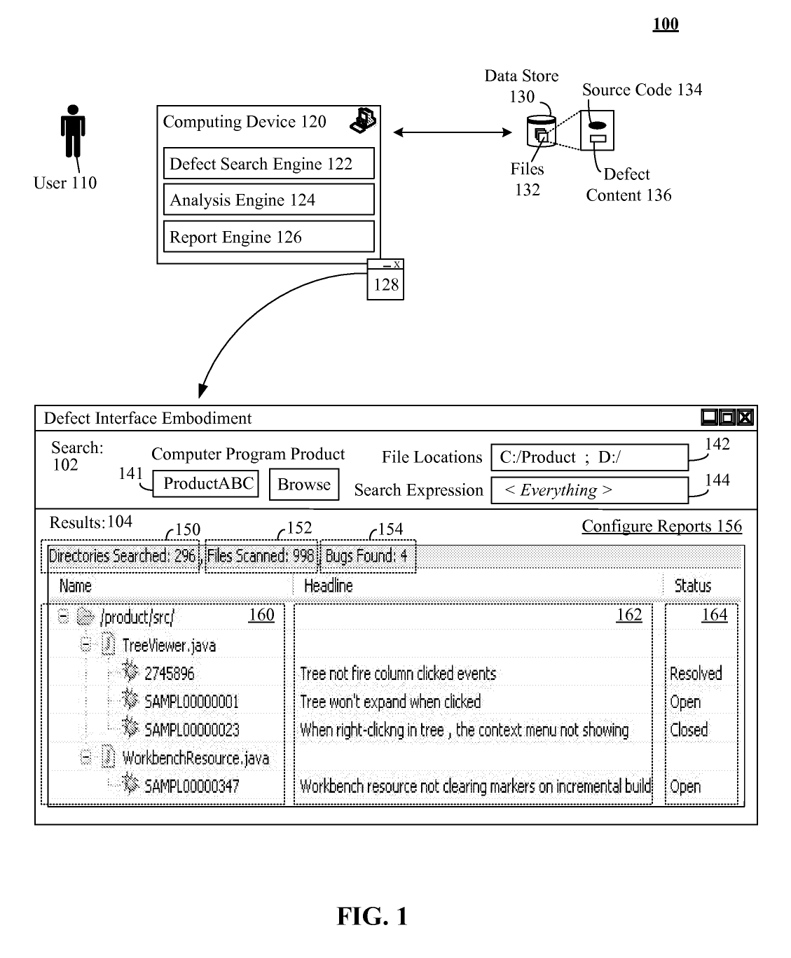

FIG. 1 shows a system 100 for using defect content 136 contained in source code 134 files 132 to assess quality of a computer program product in accordance with an embodiment of the disclosure. The defect content 136 can be searched (engine 122) and analyzed (engine 124) to produce quality reports (engine 126). Because the defect content 136 is directed stored with the source code 134, the defect content is automatically aggregated across multiple defect or change tracking systems. That is, it does not matter which change tracking system originally generated defect content 136 or what format the original content 136 was in, since it is recorded in the source code 134 in a standardized format usable by engines 122-126. Thus, source code files 132 can be transitioned through different change tracking systems over a lifetime of a computer program product, without affecting an ability of system 100 to produce quality reports based on the defect content 136.

In system 100, a data store 130 can be a tangible storage medium that includes a set of files 132. These files 132 can include source code 134 of a computer program product. The source code 134 can be any set of programmatic instructions able to ultimately be executed upon hardware of a computing device 120. A given computer program product can include any quantity (1 . . . N) of files 132. The source code 134 may have to be compiled into binary code or byte code before being executed. The source code 134 can also include code able to be directly interpreted by an interpreter.

Defect content 136 about the computer program product can be stored in the files 132. This defect content 136 can be stored in a manner that does not interfere with the use of the source code 134. For example, when the source code 134 is compiled or interpreted, the defect content 136 can be ignored by the compiler or interpreter. In one embodiment, the defect content 136 can be stored in comment fields of the source code 134. In one embodiment, the defect content 136 can be stored in meta data files of the files 132. In one embodiment, the defect content 136 can include defect information that is embedded in the file 132. In one embodiment, the defect content 136 can include references or links to defect information that is stored external to the files 132, such as being stored in a data base or in another set of files.

A user 110 can interact with a computing device 120 able to access the files 132 of data store 130. Interactions can occur through a graphical user interface 128 through input and output peripherals (e.g., keyboard, mouse, display, printer, etc.) attached to device 120. The user interface 128 can include a search 102 section within which a user 110 can specify search criteria. A defect search engine 122 can receive the criteria and can responsively search the files 132 for defects 136 matching the criteria entered within the user interface 128. An analysis engine 124 can manipulate results from the search and can compute metrics for the same. For example, the analysis engine 124 can compute a number of directories searched (150), a number of files scanned (152) and a number of defects found (154) for a given search. The report engine 126 can produce an end-user report based on results of the defect search engine 122 and the analysis engine 124. In one embodiment, reports generated by report engine 126 can be configured (156) to user customized preferences.

In one embodiment, storing the defect content 136 with the source code 134 results in a solution where defect (136) management tasks are able to be performed by stand-alone systems (e.g., device 120). That is, unlike conventional change tracking systems that often store code defects in a proprietary manner which requires access to a development environment and its proprietary resources, system 100 can store defect content 136 is a standard format and in a change tracking system independent manner.

Since the defect content 136 is stored with source code 134 analyzing source code for quality can be a self-contained process.

In one embodiment, plug-ins or add-ins can be created for a variety of software tools, so that each automatically stores defect content 136 in the files 132 whenever the defect content 136 is generated. These plug-ins or add-ins can be customized to define exactly which types of defect content 136 are to be inserted into the files 132, which may be a subset of available defect content 136. The defect content 136 can be generated and inserted into file 132 during any phase in a software lifecycle including a development phase, a deployment phase, a production phase, a maintenance phase, and combinations thereof.

Although any of a variety of user interfaces 128 can be used with system 100, in one embodiment, the user interface 128 can include a search section 102 and a result section 104 that permits a user to specify a computer program product 141 that is to be searched. The computer program product 141 can be a name of a software project or system, which includes a number of interrelated products, each with one or more source code 134 modules. Product 141 can also specify a single file 132, which may only have a single source code 134 contribution.

A user of interface 128 can also constrain a search to a set of file locations 142. For example, file locations 142 can include only configuration managed versions of a computer program product (located in a specific file location), can include all versions of a computer program product, or can include only a subset of folders/files of a computer program product. The search section 102 of interface 128 can also include an expression 144 input field, where a user can input a search expression pattern. In different contemplated embodiments, a search expression 144 can be specified as a regular expression, as a Boolean logic expression, as a set of searchable terms, as a natural language expression, and the like. In one contemplated embodiment, a search expression pattern can be specified using a GUI screen permitting a user to specify search criteria, from which a regular expression (or other search expression used by engine 122) is generated.

The user interface 128 can also include a result section 104, which visually displays (or otherwise outputs, such as to paper) quality reports for a selected computer program product. The results section 104 is shown as an interactive GUI, but can alternatively be a different type of output (e.g., printed document, fax, email, PDF document, etc.) Any number of report-level metrics (150, 152, 154) can be included in section 104. For example, a number of directories searched 150, a number of files scanned 152, and the number of defects found 154 can be calculated and displayed in one embodiment.

Result section 104 can show a directory tree 160 showing files and file locations for each of the different files 132 returned from the search 102 criteria. The directory tree 160 can be an interactive hierarchy having collapsible and expandable nodes. The directory tree 160 can show folders, programs, and components in tree view. Other views are contemplated and the disclosure is not limited in this regard.

For each file of tree section 160, a line showing defects in that file can be presented. Any number of attributes for the defects can be shown per file. Further, multiple defects can be shown per file; each defect can be shown on its own line. These attributes can include, but are not limited to, a text description of the defect 162, a unique identifier for a defect (not shown), a defect status (open, closed, resolved, etc.) 164, a submit date for the defect, a person in charge of the default, a version of the computer program product within which the defect was found, a code link for the location of the defect, and the like.

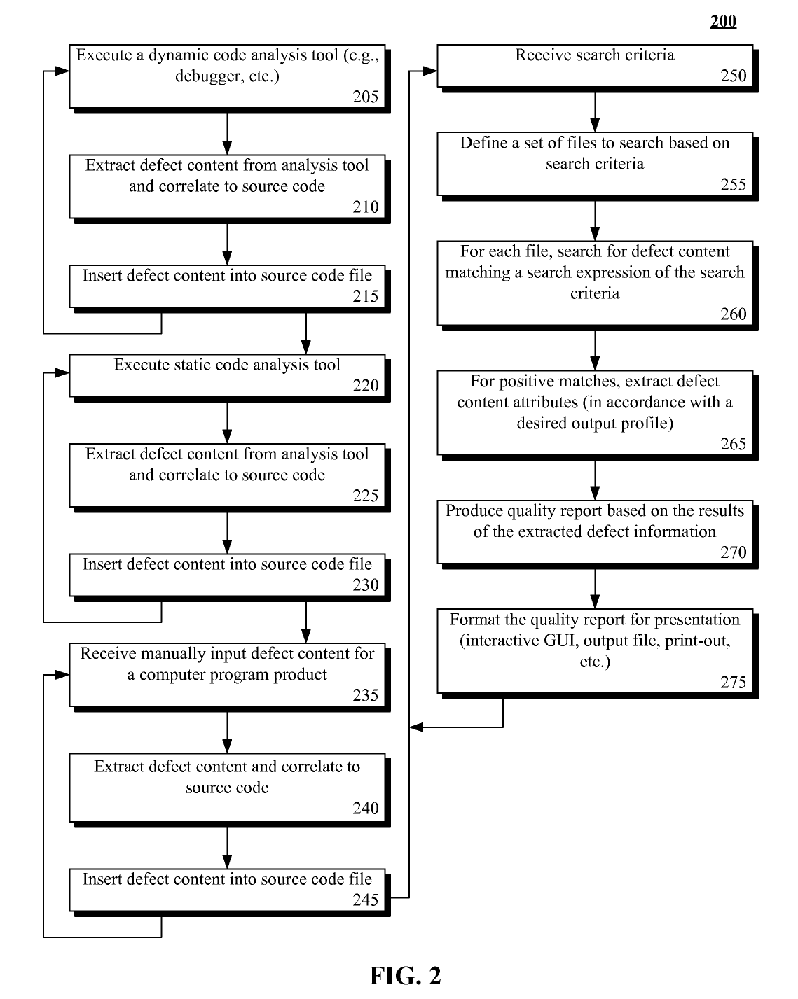

FIG. 2 is a flow chart of a method 200 for including defect content with source code and for producing quality reports based on the defect content in accordance with an embodiment of the disclosure. The method 200 can be performed in context of system 100 or any other suitable system as detailed herein.

In method 200, defect content can be placed in files having source code. This defect information can be acquired by running a dynamic code analysis tool (step 205) by running a static code analysis tool (220) and/or from manual input (step 235). The acquisition of defect content can be a continuous and iterative process that occurs in any stage of a lifecycle of a computer program product (including development, testing, deployment, production, maintenance, etc.).

For example, a dynamic code analysis tool, such as a debugger, can execute in step 205. Defect content that is correlated to source code can be extracted, as shown by step 210. This defect content can be inserted into source code in step 215. Additional runs of a dynamic code analysis tool can result in additional defect content being added to the files that contain the source code.

Statistic code analysis tools can also be used, as shown by step 220. In step 225, defect content can be extracted from a statistic code analysis task and correlated to source code. The defect content can be inserted into a source code file in step 230. Additional runs of a static code analysis tool can result in additional defect content being added to the files that contain the source code.

Manually input defect content can also be received for the computer program product, as shown by step 235. This defect content can be extracted from the manual input and correlated to source code, as shown by step 240. In step 245, the defect content can be inserted into the source code file. Manual input can be continuously received and added in a repetitive fashion.

Once the defect content is included or embedded in source code files, it can be utilized to assess a quality of the source code. Specifically, search criteria can be received in step 250. In one embodiment, this criteria can be input via a GUI interface (interface 128, for example). In step 255, a scope of a search can be defined. Specifically, a set of files, folders, and/or drives can be defined, such as by the search criteria. In step 260, each file can be searched. Specifically, defect content of the fields can be searched for information that matches a search expression (if any is defined) of the search criteria.

Each time a positive match is found, defect content attributes can be extracted from a file, as shown by step 265. In one embodiment, an output profile and/or a set of configurable report parameters can be established, in which case the extracted defect content attributes can be selected and produced based on the output profile and/or the parameters. In step 270, a computer program product quality report can be produced based on the results of the extracted information. In step 275, the quality report can be formatted for presentation. For example, the report can be formatted within an interactive GUI, within an output file, without a print-out, a fax, and the like.

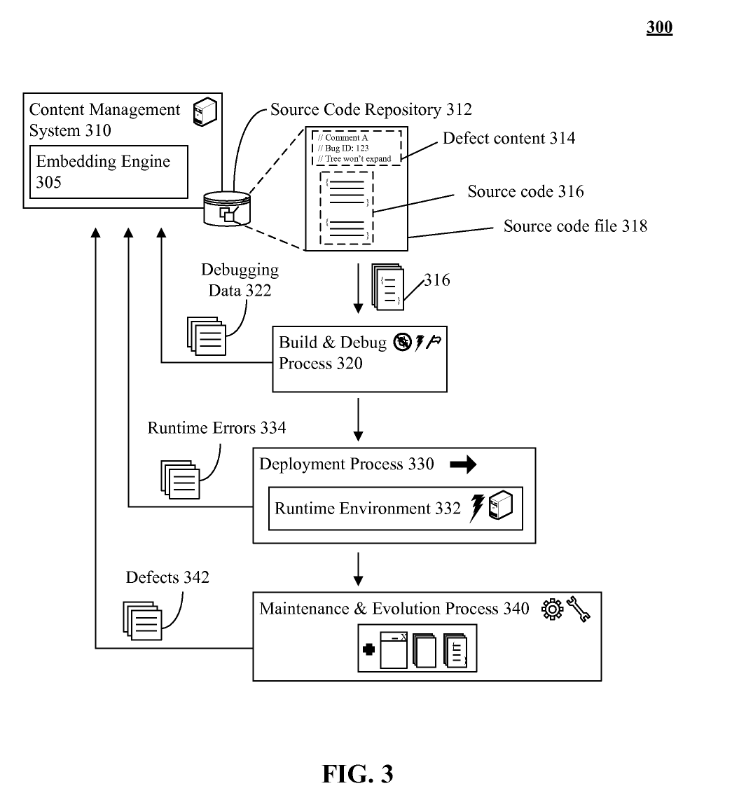

As already noted, defect content can be added to source code files in any of a variety of manners. FIG. 3 is a diagram illustrating a set of process flows for including defect content within a source code files throughout a software development process in accordance with an embodiment of the inventive arrangements disclosed herein. This included information can be used to assess a health status or a quality of code, which can be part included in a computer program product quality report.

As shown by diagram 300 of FIG. 3, during a build and debug process 320, an executable generated from source code 316 can run as part of a build and debug process 320. This process 320 produces debugging data 322 that can be sent to a content management system 310. The debugging data 322 is included as defect content 314 within the source code file 318, which also includes source code 316. The source code file 318 can be stored in a source code repository 312 of the content management system 310.

The embedding (or otherwise including) of defect content 314 into a source code file 318 is not limited to a software development phase, such as a build and debug process 320. In one embodiment, software defects (for example, runtime errors 334) encountered during a deployment process 330 and/or a runtime process (e.g., runtime environment 332) can be conveyed to system 310, where engine 305 embeds the defect information (runtime errors 334) into the source code file 318. In one embodiment, defects 342 encountered during maintenance or evolutionary process 340 can be handled by engine 305 and placed in file 318. The evolution process signifies that the computer program product detailed herein can evolve or diverge into one or more other computer program products. The defect content 314 can be conveyed into these divergent or different products as appropriate (based on which portions of source code 318 are utilized by the different product). Further, the debugging data 322, errors 334, and defects 342 that form the defect content 314 can be derived from a dynamic code analysis tool, a static code analysis tool, and/or from manual input.

As used herein, defect content 314 can include, but is not limited to, debugging data 322, runtime data 334, defect data 342, and the like. Debugging data 322 can include, but is not limited to, debugger output, watch lists, stack watch snapshots, and the like. Runtime errors 334 can comprise of defect information from one or more sources such as runtime environment 332. Runtime errors 334 can include, but are not limited to, runtime memory data, thread state information, and the like. Defect data 442 can include, but are not limited to, defect status information, user comments, defect documentation, customer feedback information, and the like. Other types of defect content 314 include developer comments, data extracted from a change tracking systems, from a project management system, from a customer service or support system (e.g., a call center or technical support center), and the like.

Source code 316 can be computer language source code expressed in a human-readable format. For instance, source code entity can be a JAVA source code file. Source code 316 as used herein includes object code.

In one embodiment, source code file 318 (or file 132) can be a single file digitally encoded on a tangible storage medium. In one embodiment, the source code file 318 can be a single storage container recognized by an operating system (more specifically by a file manager of an operating system) as a lowest discrete storage unit of content. For example, some virtualization technologies use a single file that is tangibly stored on a physical storage medium, where the single file contains an entire operating system and its set of “virtual files”, which are treated similar to standard files by the virtualized operating system. Specific ones of these virtual files containing defect content (e.g., content 136) and source code (e.g., code 134) are to be considered source code files 318 for purpose of this disclosure.

In other words, and in accordance with one embodiment of the disclosure, a container able to be treated as a single unit within an operating system , which is always moved, copied, and identified as a single unit by a file management application is to be considered a “file” (which may be a source code file 318 if it includes content 114 and code 116) for purposes of this disclosure regardless of whether the “file” 318 corresponds to a single file stored on a tangible medium or not. In such an embodiment, the “single unit” or single storage unit that is the storage entity is not a folder, a directory, or the equivalent, each of which are collection containers for a set of discrete lower level storage units. Instead, the file 318 is one of these lowest level storage units which can be placed within the collections (folders, directories, etc.).

In one embodiment, a source code file 318 is one able to be directly utilized in a manner substantially equivalent to a source code file without extraneous extractions being needed. For example, if the source code of file 318 includes interpreted language code, an interpreter can directly consume the source code file 318. Similarly, if the source code of the file 318 includes code written in a compiled language, a compiler can directly consume the source code file 318. In this embodiment, archive files, which must be expanded at least within RAM before being used, are not to be considered an entity (or a source code file 318) for purposes of the disclosure.

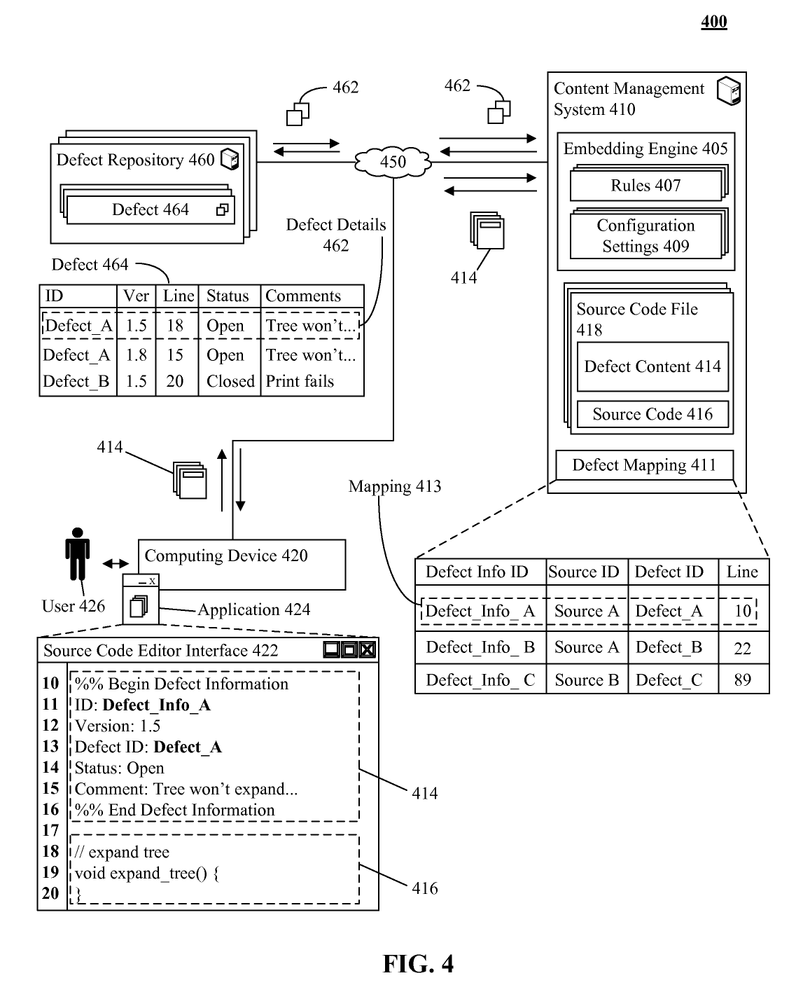

FIG. 4. is a schematic diagram illustrating a system 400 for including defect content within a source code file 418 in accordance with an embodiment of the inventive arrangements disclosed herein. That is, system 400 represents one embodiment of the invention.

In system 400, a content management system 410 can be utilized to manage defect content 414 embedded within source code file 418, which also includes source code 416. Defect details 462 associated with a defect repository 460 can be conveyed over network 450 to content management system 410. In one embodiment, defect details 462 can include bug tracking information associated with defect repository 460. Multiple different defects 464 can be stored in the repository 460.

In one embodiment, defect content 414 can be associated with a unique identification value, source information, defect details, position information, and the like. Engine 405 can utilize mapping 411 details to manage defect content 414. In one embodiment, mapping 411 data can be used to identify the position of defect content 414 within source code file 418. For instance, mapping 413 can identify the line number of embedded defect content 414 within source code file 418.

The embedding engine 405 can be a hardware/software component able to embed or otherwise include defect content 414 in file 418 in a manner in which the content 414 is correlated to source code 416. Engine 405 can include a set of rules 407 and configuration settings 409. Rules 407 can include, but is not limited to, embedding behavior parameters, defect detail filtering settings, source code filtering settings, and the like. The configuration settings 409 permit a user to adjust behavior of engine 405.

In one embodiment, source code files 418 can be presented within source code editor interface 422, which can be associated with application 424. Application 424 can be a source code editor such as an integrated development environment. For instance, application 424 can be an Integrated Development Environment (IDE) such as an ECILPSE development environment application. The interface 422 can permit a user 426 of device 420 to view and edit defect content 414, as well as view and edit source code 416.

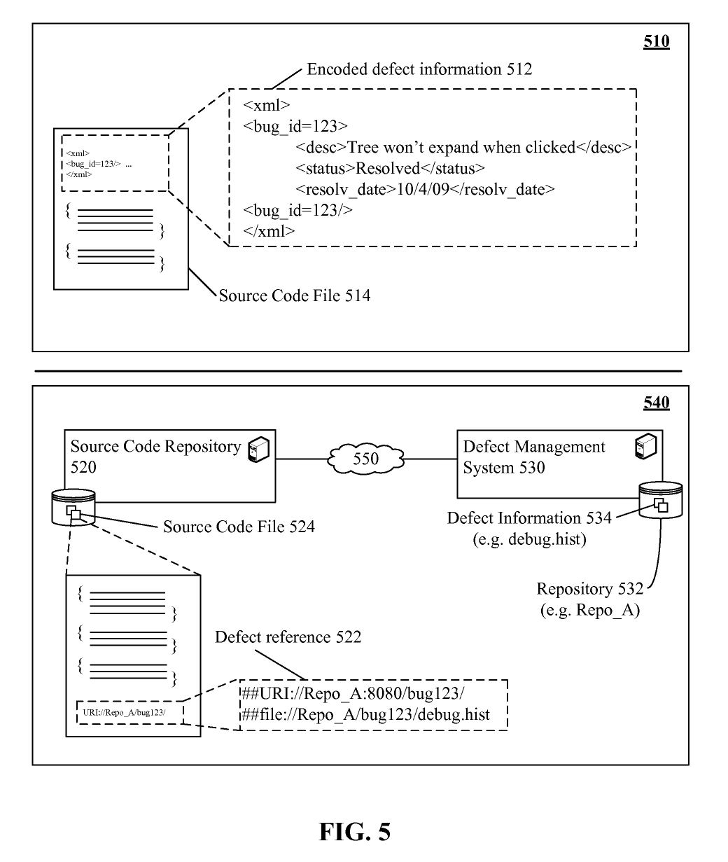

The defect content detailed herein of can be included within a source code file in a variety of ways in different contemplated embodiments of the disclosure. FIG. 5 shows two such contemplated embodiments. In embodiment 510, the defect content is embedded as defect information 512 within the source code file 514 itself This embedding of defect information 512 can occur as in-line comments, as well as within metadata of file 514. In one embodiment, defect information 512 can be written in special HTML (or XML) tags, which can facilitate searching.

In embodiment 540, references 522 to defect information 534 can be stored within the source code file 524. The references 522 can include uniform resource locators (URL's) or other unique identifiers. The defect information 534 to which the references 522 correspond can be located in a repository 532 remote from the repository 520 that stores the files 524. For example, the repository 532 including the defect information 534 can be one associated with a defect management system 530. This system 530 can be connected to the source code repository 520 via a network 550.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for producing computer program product quality reports comprising:
storing defect content, which comprises defect information or a reference to defect information, for a computer program product within source code of the computer program product;
providing a computer program product analysis tool having a graphical user interface;
specifying search criteria for defects in the computer program product via the graphical user interface;
searching the stored defect content of the source code of the computer program product based on the search criteria; and
producing a computer program product quality report for the computer program product based on results of the searching of the stored defect content.

2. The method of claim 1, wherein the results of the searching of the stored defect content comprises a plurality of different defects, said method further comprising:
for each defect, presenting within the computer program product quality report textual description of the defect and a defect status of the defect, wherein the defect status indicates at least whether the defect is open or closed, wherein the textual description and the defect status are information elements extracted from the defect content of the source code.

3. The method of claim 1, wherein the computer code product comprises a plurality of different files, wherein the defect content of each file is stored in the corresponding file, wherein the searching of the stored defect content comprises searching each of the plurality of different files, wherein the results of the searching of the stored defect information comprises a plurality of different defects; said method further comprising: for each defect, presenting within the computer program product quality report an identifier for the one of the different files to which the defect corresponds.

4. The method of claim 1, wherein the results of the searching of the stored defect content comprises a plurality of different defects, said method further comprising:
presenting within the computer program product quality report a number of directories searched, a number of files scanned, and a number of defects found during the searching to produce the results.

5. The method of claim 1, wherein the computer code product comprises a plurality of different files, wherein the defect content of each file is stored in the corresponding file, wherein the searching of the stored defect content comprises searching each of the plurality of different files, wherein the results of the searching of the stored defect content comprises a plurality of different defects; said method further comprising:
presenting within the computer program product quality report a directory tree showing folders and file locations for each of the different files having a corresponding defect, showing a plurality of different lines for each file, for each line, showing a textual description of the defect and a defect status of the defect, wherein the defect status indicates at least whether the defect is open or closed, wherein the textual description and the defect status are information elements extracted from the defect content of the source code.

6. The method of claim 1, further comprising:
presenting the computer program product quality report within the graphical user interface as an interactive directory hierarchy having expandable and collapsible nodes, wherein the interactive directory hierarchy when expanded shows each file of the source code having at least one corresponding defect, and shows a textual description of the defect, a status of the defect, and a date that the defect was submitted, wherein the presented computer program product quality report comprises a number of directories searched, a number of files scanned, and a number of defects found during the searching to produce the results.

7. The method of claim 1, wherein the defect content comprises the defect information, wherein the storing of defect content comprises:
embedding the defect information within a corresponding file comprising source code, wherein the embedding of the defect information within the corresponding file occurs in a non-interfering manner with the source code such that the embedded defect information embedded in the source code is ignored when the source code is compiled or interpreted.

8. The method of claim 1, wherein the computer code product comprises a plurality of different files each comprising a portion of the source code of the computer program product, wherein the defect content comprises the defect information, wherein the storing of defect content comprises:
embedding the defect information within a corresponding one of the different files comprising source code, wherein the embedding of the defect information within the corresponding file occurs in a non-interfering manner with the related source code such that the embedded defect information embedded in the source code is ignored when the source code is compiled or interpreted.

9. The method of claim 8, wherein the defect information is stored in comment fields of the source code.

10. The method of claim 8, wherein the defect information is stored in metadata of the different files, which is indexed against specific sections of the source code of the different files.

11. The method of claim 8, wherein the defect information is stored within markup tag fields of a markup document, wherein the markup tag fields has a specific markup tag indicating that included content comprises defect information.

12. The method of claim 1, wherein the defect content stored in the source code comprises the reference to defect information, wherein each reference to defect information references information stored in a database or file remote from the file in which the source code is stored.

13. The method of claim 1, further comprising:
running a dynamic code analysis program during a software testing phase of the lifecycle of the computer program product;
extracting data produced by running the dynamic code analysis program; and
generating the defect content that is stored within source code from the extracted data produced by running the dynamic code analysis program.

14. The method of claim 1, further comprising:
receiving defect data for the computer program product during a deployment phase, a production phase, a maintenance phase, or combinations thereof of the lifecycle of the computer program product; and
generating the defect content that is stored within source code from the received defect data.

15. The method of claim 1, further comprising:
running a static code analysis program for the computer program product;
extracting data produced by running the static code analysis program; and
generating the defect content that is stored within source code from the extracted data produced by running the static code analysis program.

16. A computer program product comprising a tangible computer readable storage medium having computer usable program code digitally encoded therewith, the computer usable program code comprising:
computer usable program code stored in a tangible medium operable to store defect content, which comprises defect information or a reference to defect information, for a computer program product within source code of the computer program product;
computer usable program code stored in a tangible medium operable to provide a computer program product analysis tool having a graphical user interface;
computer usable program code stored in a tangible medium operable to specify search criteria for defects in the computer program product via the graphical user interface;
computer usable program code stored in a tangible medium operable to search the stored defect content of the source code of the computer program product based on the search criteria; and
computer usable program code stored in a tangible medium operable to produce a computer program product quality report for the computer program product based on results of the searching of the stored defect content.

17. A system for producing computer program product quality reports comprising:
a tangible storage medium storing a plurality of different source code files, each source code file comprising source code and defect content, which comprises defect information or a reference to defect information for a computer program product defined by the source code, wherein the including of the defect content within the source code files occurs in a non-interfering manner with the source code such that the included defect content in the source code is ignored when the source code is compiled or interpreted;
a defect search engine comprising computer program code stored in a tangible medium that when executed by hardware is operable to search the different source code files for defect content matching specified search criteria;
an analysis engine comprising computer program code stored in a tangible medium that when executed by hardware is operable to manipulate matching results from the defect search engine and to compute metrics for searches conducted by the defect search engine; and
a report engine comprising computer program code stored in a tangible medium that when executed by hardware is operable to produce computer program product quality reports for computer program products based search criteria given to the defect search engine, manipulated matching results from the analysis engine and metrics computed by the analysis engine.

18. The system of claim 17, further comprising:
a computer program product analysis tool having a graphical user interface, wherein the graphical user interface comprises a search section within which a user inputs the search criteria used by the defect search engine, and wherein the graphical user interface comprises a result section within which the computer program product quality reports generated by the report engine are presented.

19. The system of claim 18, wherein the results section of the graphical user interface comprises a directory tree showing folders and file locations for each of the different files having a corresponding defect, showing a plurality of different lines for each file, for each line, showing a textual description of the defect and a defect status of the defect, wherein the defect status indicates at least whether the defect is open or closed, wherein the textual description and the defect status are information elements extracted from the defect content of the source code files.

20. The system of claim 18, wherein metrics computed by the analysis engine comprises a number of directories searched, a number of files scanned, and a number of defects found during a search based on the search criteria, wherein the reports section comprises user presented elements showing the number of directories searched, the number of files scanned, and the number of defects found.
